(19) United States
(12) Patent Application Publication
(10) Pub. No.: US 2005/0157753 A1
(43) Pub. Date: Jul. 21, 2005

(54) System and method for improving the balance between download and upload traffic on the Internet and/or other networks.

(76) Inventor: Yaron Mayer, Jerusalem (IL)

Correspondence Address: YARON MAYER, 21 AHAD HAAM ST., JERUSALEM, 92151, IL

(21) Appl. No.: 10/905,664

(22) Filed: Jan. 14, 2005

(30) Foreign Application Priority Data
Jan. 14, 2004 (CA) 2,457,969

(51) Int. Cl. H04J 3/22; H04Q 7/20; H04J 3/16

(52) U.S. Cl. 370/468; 370/437

(57) ABSTRACT

Fast connections of end users to the Internet are becoming more and more common today, and the most common types of these fast connections are ADSL and cable modems. These connections are typically highly asymmetric and allow typically 500-1500 KBit per second (most typically 750 or 1500 Kbit) for the downlink and typically for example 64 KBit or 96 Kbit or 128 Kbit per second for the uplink (although standard ADSL can in principle support up to 8 Mbit per second download speed and up to 800 Kbit per second upload speed), based on the assumption that most users download much more data than they upload. However, at least for some users these limitations are highly undesirable, and these are for example users or small businesses or organizations who want to use the connection also for example for VOIP (voice over IP) communications or Video-over IP communications or conferences or for example running web servers. Actually ADSL is beginning to be replaced by VDSL in places where the distance to the nearest street switchboard is about 1.2 Kilometers or less, which in principle allows up to 52 Mbit per second Download speed and up to 16 Mbit per Second Upload speed. However, even when end users become connected directly by fiber-optics, the typical ratio of much more Downlink versus Uplink will remain. The present invention tries to solve the problem for users who need constantly or on a changing basis more Uplink, by preferably allowing users to preferably temporarily change their Uplink-Downlink ratio on a need basis, while preferably keeping the general balance across users. Other variations allow also compensating for example for variations of the average ratio across users for example according to time of day. The patent also covers some relevant issues related to IP telephony.

This patent application claims priority from Canadian application 2,457,969 of Jan. 14, 2004, hereby incorporated by reference in its entirety.

### BACKGROUND OF THE INVENTION

1. Field of the Invention

The present invention relates to balancing download and upload speed demands on the Internet, and more specifically a System and method for improving the balance between download and upload traffic on the Internet and/or other networks for end users. (The other networks can be for example also cellular networks or other networks of interconnected devices that exist or will exist in the future).

2. Background

Fast connections of end users to the Internet are becoming more and more common today, and the most common types of these fast connections are ADSL and cable modems. These connections are typically highly asymmetric and allow typically 500-1500 KBit per second (Kbps) (most typically 750 or 1500 Kbit) for the downlink and typically for example 64 KBit or 96 Kbit or 128 Kbit per second for the uplink (although standard ADSL can in principle support up to 8 Mbit per second (Mbps) download speed and up to 800 Kbit per second upload speed), based on the assumption that most users download much more data than they upload. However, at least for some users these limitations are highly undesirable, and these are for example users or small businesses or organizations who want to use the connection also for example for VOIP (voice over IP) communications or Video-over IP communications or for example running web servers. Actually ADSL is beginning to be replaced by VDSL in places where the distance to the nearest street switchboard is about 1.2 Kilometers or less, which in principle allows up to 52 Mbit per second Download speed and up to 16 Mbit per Second Upload speed. Although VDSL modems that are based on DMT (Discrete Multi-Tone, so that it is like hundreds or thousands of modems that are simulated digitally)(for example ZipperWire VDSL) can also enable dynamically changing the allocation of frequencies to the uplink or to the downlink, thus allowing dynamic modification of the ratio, and can also simulate ADSL, ordinary ADSL does not support such dynamic changing of the ratio, and this is even more complicated for example with Cable modems. However, even such VDSL modems are not sufficient to solve the problem, since the solution needs to take into account also what happens between the street switchboard and the rest of the network. Also, the availability of such VDSL problems still does not solve the issue of how to determine the desired ratio each time. Even when end users become connected directly for example by fiber-optics, the typical ratio of much more Downlink versus Uplink will remain because on average this ratio works out for many users, however in this case the ratio is determined only by the characteristics of the bandwidth away from the user, since a “last mile” with two optic fibers per each house obviously can support almost any speed in both directions. Therefore, it would be highly desirable to have a solution that would allow end users to change the up-down ratio, preferably dynamically on a need basis, while maintaining an efficient use of the available infrastructure.

### SUMMARY OF THE INVENTION

The present invention tries to solve the problem for users who need more Uplink by preferably allowing users to preferably temporarily change their Uplink-Downlink ratio on a need basis while preferably keeping (or optimizing) the general balance across users. Other variations allow also compensating for example for variations of the average ratio across users for example according to time of day. This can be applied for example on the Internet and/or for example also in other networks such as for example cellular networks or other networks of interconnected devices that exist or will exist in the future. Preferably at least one of the following solutions is used:

Even in ADSL modems, since the maximum upload speed is typically 800 Kbps, preferably the modem can support up to this speed without any changes in hardware or software. This should be the case at least in most currently installed ADSL modems, so at least with the typical 750 Kbit subscriptions and even up to 1 Mbit, this is sufficient to allow the user to change the ratio up to 80% uplink when needed, without any changes required in the “last mile” hardware. On the other hand, if the end user needs at least part of the time even higher speeds than that, such as for example if the user pays for a bandwidth of 1.5 Mbit or more and desires flexibility of being able to shift the ratio up to for example 80% or 90% uplink, this is preferably accomplished for example either by dynamically changing the up and/or the down frequency or frequencies, and/or for example by fast time-swapping between directions (preferably many times per second), so that for example a certain percent of the time the higher frequency is used for the down link and the lower frequency for the uplink, and another percent of the time this is reversed. This time swapping can have the further advantage that since the ratio is also determined by the time ratio, preferably the two (or more) frequencies can be chosen from a wider available range of choices, since specific frequencies are no longer needed for creating the ratio itself, but instead the frequencies are preferably chosen so that on average the total sum of both up and down frequencies will be maximal. However, this of course would typically require installing different software and/or hardware in the ADSL modems at the user's end and at the street switchboard. Anyway, regardless of the way this is accomplished between the user's computer and the street switchboard, preferably, when the user requests higher upload speed, for example he/she automatically has to “pay” preferably by automatic corresponding reduction in the download speed available to him/her, and/or for example he/she is automatically charged for example an additional amount corresponding to the percent of the time that the upload link was increased and/or the percent of the time the uplink was used in practice according to the higher speed (However, if this involves some additional charge, this preferably takes into account also the total usage by that user for example during the month). The request for additional uplink speed can be done by the user preferably for example manually, for example by moving some bar, which preferably can move only within a preset range, for example between a default of for example 90% downlink and 10% uplink (9:1 ratio) up to for example 50% (1:1 ratio), or for example up to 10% downlink and 90% uplink (1:9 ratio), or any other convenient range, but preferably the user is never allowed to completely zero-down one of the directions, since that might cripple also the other direction (since for example some data requests or acknowledgements are needed also in the other direction). Another possible variation is that for example some software and/or hardware automatically senses when the user needs more or less upstream bandwidth and can preferably adjust the ratio automatically, preferably within a limited range, however preferably the user can also intervene in this, since, especially if the additional upload bandwidth comes at the expense of reduced download bandwidth at the same time, if the user is also for example downloading things at the same time, an automatic decision might not really know the user's actual priorities or intentions. Another possible variation is that the user can for example define specific hours or times and/or events in which automatically the ratio changes, so that for example in certain night hours, and/or depending for example on the user's activities or for example in his absence (determined for example automatically when the screen saver activates and/or after a certain period of inactivity on the mouse and keyboard), the uplink ratio becomes higher or lower. The same solutions can be used with VDSL, except that, as explained above, the dynamic changing of the up-down ratio between the user and the street switchbox can be easily done by dynamic allocation of the DMT frequencies, and also the range available for uplink is already up to 16 Mbps, so that the main problem in this case is not the link between the user and the street switchbox but the link further to the Internet. Similarly, if the user is connected for example by optic fibers up to his/her house/office then typically he/she has two fibers, one for the uplink and one for the downlink, with huge potential speed available on each fiber, and so the only problem becomes again accommodating the changing ratios over the rest of the infrastructure.

On the other hand, if the user has for example a cable modem, this can indeed cause a more serious problem because typically in cable modems the division between the uplink and the downlink is based on fast time-switching, in which the direction is reversed for a short percent of the time, and the ability to play with these times is also dependent on limitations of the normal cable TV data, and also the downlink (unlike for example ADSL), is typically based on sending an encrypted copy of the same data to up to 250 users on the same line (so that only the user to whom it is intended gets the data decrypted), but the uplink is based on time sharing between the users, so that if for example the uplink is 10% of the time, during this 10% uplink time the users have to send their data serially one after the other and if someone needs more uplink then his slice of the uplink time needs to be increased. So in cable modems this is preferably solved by at least one of the following solutions:

Changing the protocol to use multiple frequencies that can be dynamically allocated to the up and down links, for example in a way similar to the DMT based VDSL, however this is still problematic, since typically up to 250 users share the same line, so changing the frequencies might effect all of them (which means for example having to automatically shift one or more frequencies for example by automatic cue for all of them and/or for example using different frequencies for one or more of them for example on the same line), and also the cable TV bandwidth creates additional limitations if compatibility is kept with old analogue broadcasts in specific frequencies.

Another possible variation is for example a combination of changing the time ratio, together with letting users increase or decrease also their individual slice of the shared uplink time, and preferably if the users of higher uplink bandwidth have to “pay” by automatically reduced downlink bandwidth, then preferably in this case this reduction is based for example on lowering the priority of packets that are intended for them. Of course various combination of the above solutions are also possible, such as for example changing both the frequencies and the time ratios.

Assuming that the above solutions can solve the problem of “the last mile” to the user's house or office, the main problem then becomes accommodating these changes on the infrastructure that leads for example from a certain town or state or country to the rest of the Internet. Assuming that for large groups of people (for example an entire town or an entire state or country) on average the number of users that temporarily or even constantly want to increase their uplink bandwidth for example at the expense of their downlink bandwidth (or for an extra cost) is more or less balanced, there should be no problem in general, if for example on average the ratio of for example 9:1 or for example 8:1 is more or less constant on average. On the other hand, if for example certain fluctuations are created, for example according to hours of the day (for example in a way somewhat similar to fluctuations in electricity consumption), this is preferably accommodated for example by creating switchable lines along the infrastructure, for example on main lines that lead from a certain large metropolitan area for example to other large areas or for example to Main Routers, especially if for example a hierarchical geographical system of routers is used, as described for example in U.S. patent application Ser. No. 10/375,208 of Feb. 17, 2003, by the present inventor. These switchable lines can be easily implemented for example by dynamic frequency allocation and/or by rapid time switching of the line with a variable ratio between the up and down direction if electrical lines are used, but this solution is preferable only if the line connects just between two points, with no routers on the way. Another possible variation is for example using switches which can for example change an entire line from the down direction to the up direction for example for a few minutes or hours or more (or at least part of the line, for example over multiple nodes or routers along the way). Similarly this switching of the direction of a line between two or more routers for example for a few minutes or hours can be done for example also with optic fibers, except that is this case the switching is preferably done by optical cross-links. Preferably in all of these cases when a line's direction is changed, this change of direction is preferably automatically conveyed to all the desired routers along the way, so that the relevant optic or electric line preferably instantly becomes regarded by all the relevant routers along the desired section as an opposite-direction line. (Another possible variation is to allow such fast accommodation also with a line that is time-switched for example many times per second, but the need to update it on other routers would make it in this case less efficient).

However, increased user flexibility in determining the uplink ratio can also increase existing problems. Since even today already about 70% of Web traffic is estimated to be file swapping such as for example by Kazaa or similar programs, and similarly a large percent of the email is spam, letting end users have a higher uplink can aggravate these problems even further. Therefore, preferably this added flexibility to end users is accompanied by better security systems that prevent Trojan horses from converting end users' computers into spam-relay stations (for example as described in U.S. application Ser. No. 10/301,575 of Nov. 22, 2002 and Canadian application 2,446,144 of Oct. 20, 2003 by the present inventor), and preferably also by methods for preventing forgery of email and/or IP addresses as described for example in Israeli application 153893 of Jan. 12, 2003 and Canadian patent application 2,428,628 of May 3, 2003 by the present inventor (since spammers almost always use falsified sender email addresses), and preferably for example ISP control over uses for Kazaa-like applications, so that for example the percent of bandwidth allowed for Kazaa-like and/or other P2P file swapping applications is limited to a certain percent (for example up to 30%, or any other convenient number). This can be preferably enforced for example by a certain priority factor attached to such packets for example automatically by the ISP provider, so that for example such packets will be the first to be dropped in case of congestion. However, since various file-swapping applications might or example try to overcome this by disguising their traffic as something else, preferably the ISP software uses for example various heuristics in order to catch such attempts, and/or for example the ISP can fine users who upload too much data for example by incremental monthly fees.

In order to enforce different priorities, preferably the IP protocol is changed so that the packet header preferably carries also a priority value, which can be for example added by software on the user's computer and/or for example by the ISP (for example in routers that are closest to the end-user), so that for example the user can preferably assign this way higher priority to certain download or upload jobs, and the ISP can preferably change the priority of the user's outgoing packets and/or the priority of packets that will be sent back to the user, for example in accordance with the change in up-down ratio that the user requests and/or for example in accordance with the general bandwidth that the user is paying for. Preferably the priority set by the ISP can override any priority set by the user or by any software on the user's computer, so that preferably if the user for example requests that a certain download process will have for example double priority in comparison to another download process, this preferably affects only the ratio between download processes, but the ratio of up-down that the user requested is preferably kept by the priorities set by the ISP. In order to enable the ISP to affect for example the priority of packets that are downloaded by the user, preferably the Internet Protocol is changed so that requests for data (for example by Internet browsers and/or by other client programs on the user's computer) can carry a priority value (which is for example added by the browser or other software on the user's computer and/or by the ISP) and is preferably respected by the server that provides that data and is preferably automatically added by the server to packets sent back from it. This has the additional advantage that if for example a user has a download limit of 1.5 Mbps and a server is for example sending him/her data at a rate of 5 Mbps, preferably the ISP router can automatically for example request from the server to send the next packets with a lower priority, since transferring these packets for example up to the nearest street switchboard or up to another junction that belongs to the ISP and then dropping extra packets there causes unnecessary congestion along the way, whereas for example lowering the priority value of these packets would mean that if there is too much load on the way, such packets will preferably get dropped much earlier along the way. (Another possible variation is that if the data arrived too fast the ISP preferably keeps the extra-data in a local cache or proxy anyway, so the user continues to get it from the local cache at his/her allowed rate, instead of dropping it if it already arrived locally, which would be wasteful in any way). Although the plans for IPv6 and the Next generation Internet include the notion of adding a priority value to packets, to the best of my knowledge this has been suggested only in the context of giving certain applications higher priority due to their need to be more real-time, such as for example various streaming video applications, but not in the context of using this to balance loads according to end-link limitations. On the other hand, for example when identical packets going to the same general area are condensed into a single copy of the identical data with a multiple list of targets (as in one of the optimizations described in the above U.S. patent application Ser. No. 10/375,208), preferably the condensed packet is given highest priority (since it is much more efficient than a normal packet) and in that case preferably either the priority data is dropped (so that for example the condensed packet contains only the single copy of the data plus the list of target addresses), or for example the priority value of each original packet is kept for example together with each target address and is later used when reconstructing the original packets. The priority value shouldn't take much space since preferably just a few bits are enough for each priority value. However, since the individual packet is preferably reconstructed only when it is near to the final destination, preferably the priority value of a condensed packet can be affected also for example by the average priority value of the individual packets that were condensed into it, so that for example if the original condensed packet is replicated into smaller groups as it nears the destination, preferably the priority values of the constituent packets begin to take more effect in the smaller groups. Of course, like other features of this invention, these features can be used also independently of any other features of this invention. Of course, various combinations of the above and other variations can also be used.

If an organization (for example a large organization) is using for example one or a few VDSL modems with one or more routers coupled to them for example for multiple end-user stations (so that for example each such modem serves more than one end user), then preferably the organization can set the Up-Down ratios independently for each end-station, for example by programming the router and/or for example by enforcing the desired ratio on each end user station (or for example for each sub-group of end-stations), so that for each station this ratio can be set for example by the user and/or by the administrator and/or for example also automatically by software, for example within a certain authorized range of ratios. This has the advantage that the organization can for example create better optimizations internally and thus save costs when paying the ISP.

Of course, various combinations of the above variations can also be used, both within the various solutions and across them. Although the ability to dynamically change the up-down ratio for example between 9:1 to 1:9 may seem small compared for example to the improvements of up to hundreds or thousands of times described in the above U.S. application Ser. No. 10/375,208, it should be kept in mind that if someone for example wants to run a server on his home or office and wants for example to increase the ratio from 9:1 down-up to 1:9 up-down, then in practice this is a 9-fold increase, and so even if for example the optimizations described in application Ser. No. 10/375,208 allow a thousand time increase over prior art systems, the present invention can increase this further, thus becoming for example altogether a 10,000 times increase.

If the increased uplink ratio is used for example also to enable more efficient telephony (i.e. Voice-Over-IP—VOIP) and/or for example Video-Over-IP, preferably the IP telephony and/or Video over IP uses at least one of the following features for increasing efficiency and/or convenience to the users:

Preferably a single, preferably normal-looking, phone is used, which can preferably automatically switch between normal phone line to IP telephony (This preferably means that the user uses IP telephony directly through the Internet, as compared for example to a case where the phone company itself applies VOIP for at least part of the way), and/or for example also to telephony through a cable modem (However, preferably the phone contains a display screen and has at least access to various menus). This is preferably done for example by using a special phone which has this switching ability, or, more preferably, by adding a switchbox to which preferably the user plugs his/her normal phone (preferably through a standard phone socket), so that the box itself is preferably connected both to the normal phone line and to the Internet (In this case for example the switchbox itself and/or the phone can have display screens and menus), for example directly for example through an ADSL or VDSL router or modem or for example optic fiber router or modem, or for example through the user's computer (for example though a USB link), thus connecting for example to the ADSL or VDSL modem through the user's computer. If the ADSL/VDSL modem is also a router or is coupled to a router, there should be no problem to connect for example both the computer and the special switchbox (or special phone) directly to the router, otherwise (since a normal ADSL or VDSL modem has only one input socket) preferably either the switchbox (or special phone) is connected to the modem only through the computer (for example through the USB link), or the computer is connected to the modem only through the special switchbox (or special phone), in which case the switch box (or special phone) preferably performs also the function of a router. This configuration has the additional advantage that the user can conveniently use the normal phone that he/she is used to talk with normally—even when talking through the Internet, instead of the inconvenience of typically connecting a microphone to the sound card and hearing for example through the speakers. If the switch box enables for example linking also to a cable telephony system then a similar link can be used for example directly to a cable modem or cable router, or again through the computer, however if the cable modem is used only to connect to the Internet, then of course the box can use this link the same way as the ADSL Internet link. (Of course, the phone companies themselves may use also VOIP (Voice-Over-IP) increasingly over the next few years for at least part of the way, but when using the phone-company's infrastructure the user typically still pays much more than when using directly IP telephony through the Internet). When an incoming call arrives, preferably the switch-box (or special phone) automatically routes the appropriate channel to the phone and for example converts it from digital to analogue data as needed, and preferably indicates to the user which type of phone-call it is (for example Internet-telephony, Cable company telephony, or normal phone-call). Preferably even for Internet or Cable telephony the system is able to display also caller ID. In the case of Internet telephony this is preferably enabled by similar methods to those used for preventing forgery of email and/or IP addresses as described for example in the above Canadian patent application 2,428,628 of May 3, 2003 by the present inventor. When the user initiates a call, preferably he/she can indicate for example by an appropriate switch or for example by an appropriate prefix which type of phone call he/she prefers it to be, and/or for example the system by default first tries to make it an Internet-phone call and only if that is not possible then the system for example automatically reverts to normal phone call, and, again, preferably the system indicates to the user for example by visual display which type of phone call has been established.

In order to solve the problem of compatibility of numbers, preferably one or more phone-table server databases are available over the Internet (for example in a way similar to Domain name Servers), so that the Internet identity of users (for example email addresses and/or IP addresses and/or Instant Messaging Ids) can be linked to their normal phone numbers. This way for example when dialing a “normal” number through the Internet, the system preferably automatically first goes to one of these phone-number-servers to check if such a phone number (including preferably international code, etc.) already has an Internet identity linked to it. Of course, like other features of this invention, these features can be used also independently of any other features of this invention.

In order to prevent people from illegally “hijacking” a phone number of a person or a company and linking it to the wrong Internet identity, preferably users can get an entry that links a phone number with a given Internet identity only upon submitting sufficient evidence that they are indeed who they claim to be and indeed own the phone number in question or have the right to assign it, and preferably this proof has to be submitted to one or more Internet authorities and/or for example phone company authorities. This has the further advantage that users who call or receive a call from such a phone through direct Internet telephony (without having to go through the phone company), can be more sure of the identity of the person or organization that the phone number belongs to in a way similar to the way that normal phone companies infrastructure creates such authentication.

Another possible variation is that if the user is connected for example through ADSL or VDSL, since at least the phone company's switchboard and/or the ISP can know both the real phone number though which the user is connected and his/her IP address (according to the physical coupling between the specific ADSL-enabled phone number and the assigned IP address), this address can preferably be automatically updated for example by the ISP in the special phone-server Databases, so that if for example the user has a constant IP address then this updating needs to be done only once (until that IP address changes) and if for example the user gets a different IP address each time he/she opens the ADSL or VDSL connection, then this is preferably automatically updated preferably by the ISP at the special Phone-table severs. Of course similar mechanisms can be used for example for other types of connections, such as for example last mile optical fibers or other broadband solutions.

Another possible variation is that for example the ISP and/or for example preferably only the Phone company and/or for example another special authority can issue the user for example a special phone (that preferably contains the switchbox in it) or a special switchbox which contains within its hardware a unique code that identifies the user and preferably links him/her to one or more authorized phone numbers, or for example a special smart card or other hardware or physical key which can be inserted in these special telephones or switchboxes and similarly identifies the user and preferably links him/her to one or more authorized phone numbers, so that preferably whenever the user connects the hardware that contains his/her special ID to an appropriate phone or switchboard, this can automatically become his/her authorized link preferably as long as it is connected, and thus for example the ISP is automatically instructed to update for example the special Internet Phone-table servers with the current IP to which the user is connected, thus automatically routing all the calls to and/or from his phone number to that IP address. Of course using a special smart-card has the advantage that if these switchboxes or special phone become common items that almost any user has, the user only has to carry his smart card with him when traveling instead of carrying with him/her a special phone or switchbox. In addition, if for example such a card is used, preferably the user also has to key-in a password, preferably through the keyboard of the phone that is connected to the system, so that if the card is stolen it cannot be used to steal the user's Internet phone-link without the password. Another possible variation is that the smart card or other physical key can communicate with the special phone or switchbox for example by RFID technology (or for example other short range wireless technology), so that for example the user simply has to be near the special phone or switchbox for example at a range of one meter or less (or any other desired range). However, if such technology is used, preferably it includes also encryption keys and a code that changes automatically according to the time and date, so that the signal cannot be recorded and replayed by someone else.

Of course, various combinations of the above variations can also be used, both within the various solutions and across them. Preferably in any of the above variations, or at least if the IP address that has most recently been authorized for a certain phone is a non-constant IP address or does not normally belong to that user (but has been for example temporarily authorized for that user by connecting the relevant hardware that identifies the user), preferably the ISP automatically invalidates the entry in the Phone table servers that links to that IP address as soon as the user disconnects from that Internet link and/or removes the special hardware ID that identifies him/her, so that any subsequent attempts by someone else to phone that user through the Internet will not be directed to that IP address. Another possible variation is that anytime the user disconnects even from a constant IP address the system automatically sets a flag at the Phone table servers that indicates that the user is not currently Online and resets it to Online when the user becomes online again, for example in a away similar to IM networks. In addition, preferably in this case the system also takes into account if the user is active at the computer or not, so that for example if the user has not typed anything or clicked anything for more than a certain time limit the system can automatically assume that he is not really Online even if his computer is still connected to the Internet. In addition, preferably in any of the above variations preferably if someone tries to phone a user through the Internet and the relevant link in the Internet Phone-tables servers is no longer valid and/or the user is not currently Online, then preferably the appropriate switchbox of the phoning user automatically switches to phoning through the normal phone company infrastructure and preferably indicates to the phoning user that the link cannot currently be made directly through the Internet, and preferably asks the user's authorization if to continue with the call or not or for example try again later through the Internet. Preferably the phoning user has also an option of for example automatic “Internet Phone redialing” attempts so that for example the system automatically checks again for example every few minutes (or any other convenient interval) if the Phone-tables servers entry for the desired called user have been updated with a new currently valid IP address and/or if the desired user has become Online again, and when that happens for example informs the calling user for example by a special ring that direct Internet connection to the desired user is now available and then for example if the phoning user picks up the phone, connects to the desired user directly through the Internet. Another possible variation is that the system for example first tries to establish the actual connection through the internet and then uses the special ring to alert the phoning user, but preferably in that case the corresponding Internet phone at the called user only gets for example a notice that a phone call is pending but is not instructed to actually ring as long as the phoning user has not picked up the phone, otherwise the called user might hear a ring for example even if the user that tried to phone him/her has gone away in the meantime. Another possible variation is that the phoning user can for example ring the desired user through normal telephony and if both users are near their computer or near some other Internet link that they can use, then they can both for example press some button for example on the phone or on the switchbox or for example activate some option in the computer, and then preferably the phone-call can immediately be switched to direct IP telephony through the internet preferably without them having to hang-up and reconnect. This can be done for example by the 2 users pressing the appropriate button at approximately the same time, or for example as soon as one of them does it, his system preferably automatically informs the other user's system, and then the other user's system preferably automatically checks if the other user can also revert to IP telephony and in that case preferably switches over automatically even if the other user has not pressed the convert switch, and/or for example the two phones automatically check if they can make the switch into direct IP telephony and if it is possible then preferably they automatically make this switch even without any request on part of either of the users. For example if the calling user does not know the Internet phone number of the called user and/or his/her current IP address and/or other data needed for direct VOIP contact, preferably the calling user's phone can preferably first call the other user through normal telephony and then preferably in a few seconds or less or even less than a second preferably automatically exchange internet phone numbers with the called user's phone and/or exchange other internet information, such as for example current IP, etc. and then the two phones can preferably immediately preferably automatically switch to IP telephony, preferably accompanied by some visual and/or auditory indication to the two (or more) users that the routing has been automatically switched to VOIP. Preferably this can work automatically also for example with cellular phones, so that preferably the cellular phone for example automatically includes also the special ID that uniquely identifies the user, and if the user is for example near enough to some Internet link, the phone can preferably automatically revert to IP telephony, preferably while indicating to the user when IP telephony is connected or disconnected. Another possible variation is that this service can be offered for example by the phone companies and/or by the cellular companies themselves so that for example even if only one of the users is near an Internet link the phone call can automatically revert to IP telephony on this side and normal Cellular or non-cellular telephony on the other user's side, and in that case preferably the users also get a special indication (for example visually and/or vocally) about the current version of the call, and in such calls the user can be for example charged only half-price or some other accepted reduction. Of course, such a hybrid-configuration service can be offered for example also by 3^{rd} parties, for example by automatically switching over to the appropriate phone service near the other user, but such a service is regarded illegal in most places unless given permission also by the relevant phone company. Of course, like other features of this invention, these features can be used also independently of any other features of this invention, so that for example these features can be made available in normal IP telephony, for example when users use VOIP communications when connected through an IM (Instant Messaging) network, so that for example the phone can alert the phoning user whenever the desired party becomes connected (In this case for example the system can simply check with the relevant IM server if the user has become connected and/or for example connecting to the IM network automatically updates also the link in the relevant phone number servers, and thus the system can check directly there). In addition, preferably the IP phone or the switchbox has the ability to indicate for example if the user is busy with another phone call, so that if for example a normal phone-call comes in and the user is currently talking on the phone (either normally or through the Internet) then the switchbox or the special phone or the system (or for example through a software on the user's computer) can preferably indicate to the phone company that the line is busy (for example by automatically signaling to the phone company an “open phone” even if the user is currently speaking through the Internet), and/or for example indicate to the user that there is an incoming call (preferably including the incoming call's id, displayed for example on a screen on the switchbox or on the special phone or for example on the user's computer) and preferably allow him/her to switch to that call if he/she so desires, or for example such call can be automatically routed to an answering system for example on the user's phone or switchbox or coupled to them or for example on the user's computer, or for example on a phone company server, if the user is subscribed to such a service. Similarly, if the incoming call is for example through the Internet telephony, and the user is for example currently speaking with someone else through the normal telephony infrastructure or through the direct Internet telephony, preferably similar options are available to the called user and preferably the Internet phone protocol indicates a busy signal to the calling user (and in this case any automatic answering system is preferably implemented either on the called user's phone or switchbox or coupled to them and/or is provided preferably by software on the called user's computer). Of course, using a special switchbox instead of a special phone has the advantage that the user can still choose whatever normal phone he likes to use, thus having a much wider selection of actual phones, and also this way the user can for example transparently also connect for example a Fax machine and/or for example an automatic answering system. Preferably the same principles of dealing with incoming calls while the phone is occupied can be applied also if the user for example has temporarily converted the special phone or the switchboard at another user's station (for example in a friend's house or in another room in a accompany) to be his IP phone end-user location. Another possible variation is that if for example a switch-box is used, it can have for example 2 or more exits so that for example two or more phones can be hooked up and used at the same time (preferably independently of each other, through the VOIP). Of course, like other features of this invention, these features can be used also independently of any other features of this invention. Of course, various combinations of the above and other variations are also possible.

### BRIEF DESCRIPTION OF THE DRAWINGS

FIG. 1 is an illustration of a typical configuration of connecting end users through ADSL or VDSL modems.

FIG. 2 is an illustration of a preferable variation of dynamically changing the direction of communication lines.

FIGS. 3 a-b are illustrations of preferable variations of including priority data in normal packets and in condensed packets.

FIGS. 4 a-b are illustrations of preferable configurations of connecting a special phone or special switchbox so that the same device can be used for normal phone conversation and for Internet phone conversations.

### IMPORTANT CLARIFICATION AND GLOSSARY

Throughout the patent whenever variations or various solutions are mentioned, it is also possible to use combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable subcombination. All the drawings are just exemplary diagrams. They should not be interpreted as literal positioning, shapes, angles, or sizes of the various elements. When used throughout the text of this patent, including the claims, “IP Address” stands for “Internet Protocol Address”. However, throughout this patent, including the claims, this address is used as a logical concept and does not necessarily depend on a specific implementation, so the concepts of this patent can work with any implementation or kind of target address. Throughout the patent, including the claims, ISP refers to Internet Service Provider, which typically means infrastructure companies that sell to end users the Internet connection.

### DETAILED DESCRIPTION OF THE PREFERRED EMBODIMENTS

All of the descriptions in this and other sections are intended to be illustrative examples and not limiting.

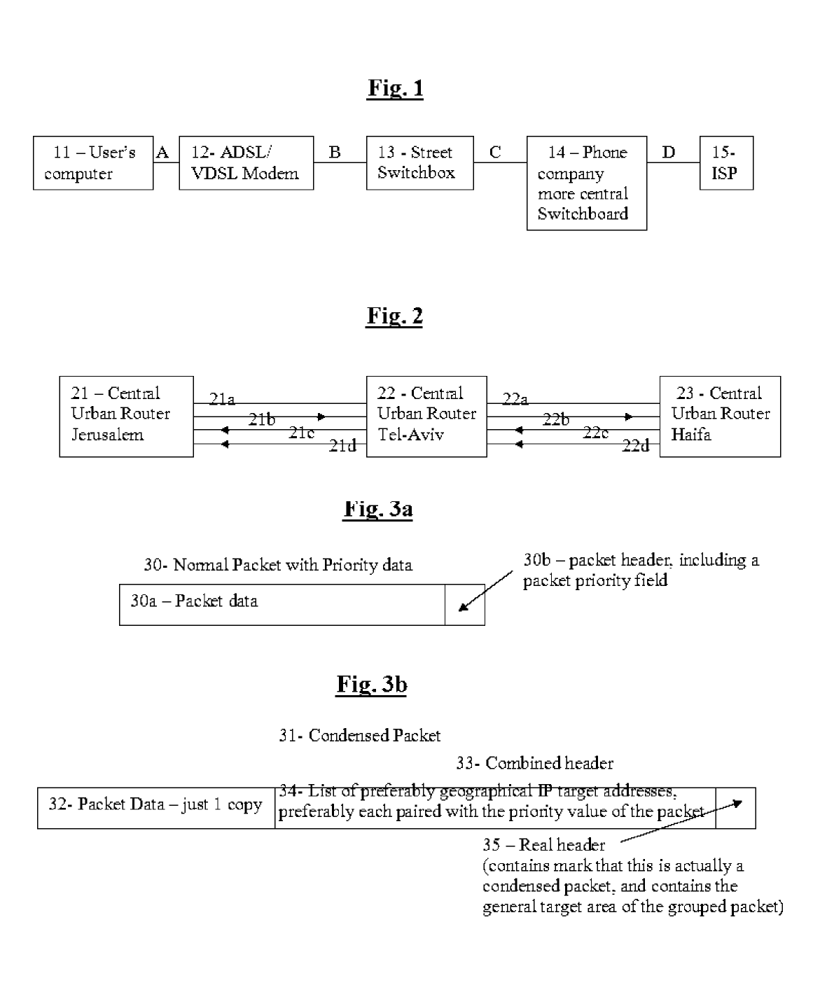

Referring to FIG. 1, I show an illustration of a typical configuration of connecting end users through ADSL or VDSL modems. As can be seen, typically the user's computer (11) is connected to an ADSL or VDSL modem (12) (typically thorough a network card or through a USB connection (A)), and the modem is connected through normal phone company copper wires (B) to a corresponding modem in a nearby street switchboard (13). The street switchboard can be connected to a more central switchboard of the phone company for example through better connections—such as for example broadband electrical lines or optical fibers (C), which can be for example two fibers for each line, or for example the same optical fibers are used for more than one line. The phone company's more central switchboard is then connected to the ISP, again for example through broadband electrical lines or optic fibers (D).

FIG. 2 is an illustration of a preferable variation of dynamically changing the direction of communication lines. Assuming that the above solutions can solve the problem of “the last mile” to the user's house or office, the main problem then becomes accommodating these changes on the infrastructure that leads for example from a certain town or state or country to the rest of the Internet. Assuming that for in large groups of people (for example an entire town or an entire state or country) on average the number of users that temporarily want to increase their uplink bandwidth at the expense of their downlink bandwidth is more or less balanced, there should be no problem in general, if for example on average the ratio of for example 9:1 or for example 8:1 is more or less constant on average. On the other hand, if for example certain fluctuations are created, for example according to hours of the day (for example in a way somewhat similar to fluctuations in electricity consumption), this is preferably accommodated for example by creating switchable lines along the infrastructure, for example on main lines that lead from a certain large metropolitan area for example to other large areas or for example to Main Routers, especially if for example a hierarchical geographical system of routers is used, as described for example in U.S. patent application Ser. No. 10/375,208 of Feb. 17, 2003, by the present inventor (of course, at least some of the large metropolitan routers can themselves be MAIN routers, i.e. routers that are in the highest level of the hierarchy and preferably have direct links to other MAIN routers without having to go through lower level routers in order to reach them). If electrical lines are used, these switchable lines can be easily implemented for example by dynamic frequency allocation or by rapid time switching of the line with a variable ratio between the up and down direction (for example multiple times per second), but this solution is preferable only between two points, with no routers on the way. Another possible variation is for example using switches which can for example change an entire line from the down direction to the up direction for example for a few minutes or a few hours. Similarly this switching of the direction of an entire line for example for a few hours can be done for example also with optic fibers, except that is this case the switching is preferably done by optical cross-links. Preferably in all of these cases when a line's direction is changed, this change of direction is preferably automatically conveyed to all the desired routers along the way, so that the relevant optic or electric line preferably instantly becomes regarded by all the relevant routers along the desired section as an opposite-direction line. (Another possible variation is to allow such fast accommodation also with a line that is time-switched for example many times per second, but the need to update it on other routers would make it in this case less efficient). So in this example for example 3 central urban routers (12-23) are shown (these would be typically either MAIN routers or intermediate level routers in the hierarchy, depending for example on the size of the area) which are connected for example by optic fibers, and for example part of the time for example lines 21a & 22a can be reversed in direction (for example a few hours each time). On the other hand for example lines 21b and 22b have a direction from Jerusalem to Haifa and lines 21c, 22c, 21d & 22d have a direction from Haifa to Jerusalem. So in this example reversing lines 21 & 22a (preferably with correlation between them) can change the ratio between 2:2 to 1:4. Of course this is just an example and between major urban areas the needed ratios between both directions will typically be more or less equal. Of course this is just an example and more or less links might be used. Lines 21b-d and lines 22b-d can be for example non-switchable, or for example more lines or all the lines can be switchable. Lines 21a and 22a are preferably reversed in synchrony, but since various sections of the net might have different needs, another possible variation is for example that each pair of routers can reverse one or more lines between them according to various needs without necessarily reversing them with other routers. Of course, in addition to the preferably direct connections between the central urban routers, there can be also for example lower bandwitdh connections which go between lower level routers that reach smaller areas, for example various routers in smaller settlements between Jerusalem and Tel-Aviv. Preferably in these lower level connections similar switchable lines can also be used, and in this case typically the ratio can be more downlink than uplink, assuming that there are for example more end-users there than servers.

FIGS. 3 a-b are illustrations of preferable variations of including priority data in normal packets and in condensed packets. In a normal packet with priority data (30) preferably the priority data is included as part of the header (30b). On the other hand, a condensed packet (31) preferably contains just a single copy of the identical data (32) and an extended header (33), which contains a normal header (35) (preferably with a mark that indicates that this is actually a condensed packet), and a list (34) of the preferably physical (geographic) IP target addresses of the original packets that contained the same identical data in their body and were condensed in this group. So, if priority data is included, preferably each IP target address in list 34 is paired together with the priority data of that packet, so that when individual packets are reconstructed from the condensed packed, the priority data of each original packet can be restored. Another possible variation is for example to divide list 34 into two parts, so that for example one part contains only the IP target addresses and one part contains correspondingly only the priority values.

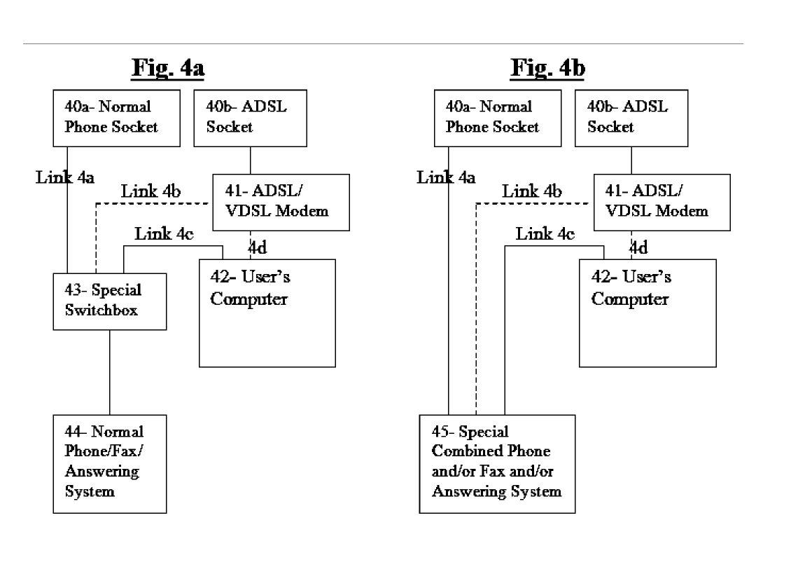

FIGS. 4 a-b are illustrations of preferable configurations of connecting a special phone or special switchbox so that the same device can be used for normal phone conversation and for Internet phone conversations. Preferably a single, preferably normal-looking phone, is used, which can preferably automatically switch between normal phone line to IP telephony (This preferably means that the user uses IP telephony directly through the Internet, as compared for example to a case where the phone company itself applies VOIP for at least part of the way), and/or for example also to telephony through a cable modem. This is preferably done for example by using a special phone which has this switching ability (45) (which might also include for example a fax and/or answering system for example in the same device or for example the phone is connected together with them, so that preferably they are connected to a socket in the special phone, thus benefiting automatically from whatever type of connection the phone enables), or, more preferably, by adding a special switchbox (43) to which preferably the user plugs his/her normal phone (44) (preferably through a standard phone socket, and in this case any other devices, such as for example fax and/or answering machine can be normally connected to the same line), so that the box itself is preferably connected both to the normal phone line (40a) through link 4a and to the Internet, for example directly for example through an ADSL or VDSL router or modem (41) through link 4b or for example optic fiber router or modem, or for example through the user's computer (for example through a USB link), thus connecting for example to the ADSL or VDSL modem through the user's computer (42). If the ADSL/VDSL modem (41) is also a router or is coupled to a router, there should be no problem to connect for example both the computer (42) and the special switchbox (or special phone) directly to the router, otherwise (since a normal ADSL or VDSL modem typically has only one input socket) preferably either the switchbox (or special phone) is connected to the modem (41) only through the computer (for example through the USB link), or the computer is connected to the modem only through the special switchbox (or special phone), in which case the switch box (or special phone) preferably performs also the function of a router. As can be seen, link c between the switch box (or the special phone) and the computer preferably exists in both configurations, however, in case of the modem (41) being also a router, both the switchbox and the computer are preferably connected to the router/modem through link 4d, otherwise preferably both are connected to the modem through link 4b, and in this case the special switchbox (or special phone) preferably also works like a router. This configuration has the additional advantage that the user can conveniently use the normal phone that he/she is used to talk with normally—even when talking through the Internet, instead of the inconvenience of typically connecting a microphone to the sound card and hearing for example through the speakers. If the switch box enables for example linking also to a cable telephony system then a similar link can be used for example directly to a cable modem or cable router, or again through the computer, however if the cable modem is used only to connect to the Internet, then of course the box can use this link the same way as the ADSL Internet link. (Of course, the phone companies themselves may use also VOIP (Voice-Over-IP) increasingly over the next few years for at least part of the way, but when using the phone-company's infrastructure the user typically still pays much more then when using directly IP telephony through the Internet). When an incoming call arrives, preferably the switch-box automatically routes the appropriate channel to the phone and for example converts it from digital to analogue data as needed, and preferably indicates to the user which type of phone-call it is (for example Internet-telephony, Cable company telephony, or normal phone-call). Preferably even for Internet or Cable telephony the system is able to display also caller ID. In the case of Internet telephony this is preferably enabled by similar methods to those used for preventing forgery of email and/or IP addresses as described for example in the above Canadian patent application 2,428,628 of May 3, 2003 by the present inventor. When the user initiates a call, preferably he/she can indicate for example by an appropriate switch or for example by an appropriate prefix which type of phone call he/she prefers it to be, and/or for example the system by default first tries to make it an Internet-phone call and only if that is not possible then the system for example automatically reverts to normal phone call, and again preferably the system indicates to the user for example by visual display and/or vocally which type of phone call has been established.

While the invention has been described with respect to a limited number of embodiments, it will be appreciated that many variations, modifications, expansions and other applications of the invention may be made which are included within the scope of the present invention, as would be obvious to those skilled in the art.

1-18. (canceled)

19. A method that allows users to change their Uplink-Downlink ratio on at least one of the Internet and other networks, while keeping a general balance across users, comprising at least one of the following steps:
a. Compensating for variations or fluctuations of the average ratio across users by using lines with switchable directions at least part of the way;
b. Allowing users to flexibly define their desired Up-Down ratio.

20. The method of claim 19 wherein ADSL modems can at least one of:
a. Dynamically change the up and/or the down frequency or frequencies;
b. Use time-swapping between directions, so that a certain percent of the time the higher frequency is used for the down link and the lower frequency for the uplink, and another percent of the time this is reversed.

21. The method of claim 19 wherein when the user requests higher upload speed, at least one of the following features exists:
a. The user automatically has to “pay” by automatic corresponding reduction in the download speed available to him/her;
b. The user is automatically charged an additional amount corresponding to the percent of the time that the upload link was increased and/or the percent of the time the uplink was used in practice according to the higher speed;
c. The request for additional uplink speed can be done by the user manually in a way that can move only within a preset range;
d. Some software and/or hardware automatically senses when the user needs more upstream bandwidth, however the user can also intervene in this since an automatic decision might not really know the user's priorities;
e. The user can define specific hours or times and/or events in which automatically the ratio changes.

22. The method of claim 19 wherein in cable modems at least one of the following features exists:
a. The protocol is changed to use multiple frequencies that can be dynamically allocated to the up and down links;
b. Different frequencies are used for one or more of the users on the same line;
c. A combination of changing the time ratio together with letting users increase or decrease also their individual slice of the shared uplink time;
d. If the users of higher uplink bandwidth have to “pay” by automatically reduced downlink bandwidth, then this reduction is based on lowering the priority of packets that are intended to them.

23. The method of claim 19 wherein lines with switchable direction between routers on the network are implemented by at least one of:
a. Dynamic frequency allocation;
b. Rapid time switching of the line with a variable ratio between the Up and down direction if electrical lines are used;
c. Using switches which can change an entire line or a section of a line across multiple routers from the down direction to the up direction for a few minutes or hours or more:
d. In optic fibers switching of the direction of a line can be done by optical cross-links;
e. When a line's direction is changed, this change of direction is automatically conveyed to all the desired routers along the way, so that the relevant optic or electric line becomes regarded by all the relevant routers along the desired section as an opposite-direction line;
f. Each pair of routers can reverse one or more lines between them according to various needs without necessarily reversing them with other routers.

24. The method of claim 19 wherein the system prevents forgery of email and/or IP addresses in order to compensate for the increased ability to send outgoing email messages.

25. The method of claim 19 wherein in order to enforce different priorities at least one of the following features exists:
a. The IP protocol is changed so that the packet header carries also a priority value, which can be added by at least one of software on the user's computer and/or by the ISP;
b. The user can assign higher priority to certain download or upload jobs, and the ISP can change the priority of the user's outgoing packets and/or the priority of packets that will be sent back to the user;
c. The priority set by the ISP can override any priority set by the user or by any software on the user's computer;
d. In order to enable the ISP to affect the priority of packets that are downloaded by the user, the Internet Protocol is changed so that requests for data can carry a priority value which is respected by the server that provides that data and is automatically added by the server to packets sent back from it;
e. If identical packets going to the same general area are condensed into a single copy of the identical data with a multiple list of targets, the condensed packet is given highest priority, and the priority data is dropped or the priority value is kept for each target address and is later used when reconstructing the original packets;
f. If the original condensed packet is replicated into smaller groups as it nears the destination, the priority values of the constituent packets begin to take more effect in the smaller groups.

26. A method that allows to enforce different priorities on packets in order to enforce different priorities to various tasks as defined by the user and/or by the ISP, comprising at least one of the following steps:
a. Changing the IP protocol so that the packet header carries also a priority value, which can be added by at least one of software on the user's computer and/or by the ISP;
b. Allowing the user to assign higher priority to certain download or upload jobs, and the ISP can change the priority of the user's outgoing packets and/or the priority of packets that will be sent back to the user;
c. The priority set by the ISP can override any priority set by the user or by any software on the user's computer;
d. In order to enable the ISP to affect the priority of packets that are downloaded by the user, the Internet Protocol is changed so that requests for data can carry a priority value which is respected by the server that provides that data and is automatically added by the server to packets sent back from it;
e. If identical packets going to the same general area are condensed into a single copy of the identical data with a multiple list of targets, the condensed packet is given highest priority, and the priority data is dropped or the priority value is kept for each target address and is later used when reconstructing the original packets;
f. If the original condensed packet is replicated into smaller groups as it nears the destination, the priority values of the constituent packets begin to take more effect in the smaller groups.

27. The method of claim 19 wherein if an organization is using one or a few modems with one or more routers coupled to them for multiple end-user stations, the organization can set the Up-Down ratios independently for each end-station.

28. The method of claim 19 wherein the increased uplink ratio is used to enable more efficient Voice-Over-IP and/or Video-Over-IP.

29. The method of claim 28 wherein at least one of the following features exists:
a. A single phone is used which can be used both for normal phone line and for IP telephony directly through the Internet;
b. A single phone is used which can automatically switch between normal phone line to IP telephony directly through the Internet;
c. In order to solve the problem of compatibility of numbers, one or more phone-table server databases are available over the Internet, so that the Internet identity of users can be linked to their phone numbers, so that when dialing a “normal” number through the Internet, the system automatically first goes to one of these phone-number-servers to check if such a phone number already has an Internet identity linked to it;
d. In order to prevent people from illegally “hijacking” a phone number of a person or a company and linking it to the wrong Internet identity, users can get an entry that links a phone number with a given Internet identity only upon submitting sufficient evidence that they are indeed who the claim to be and indeed own the phone number in question or have the right to assign it;
e. If the user is connected through ADSL or VDSL, since at least the phone company's switchboard and/or the ISP can know both real the phone number though which the user is connected and his/her IP address, this address can be automatically updated in the special phone-server Databases.

30. A method that enables users to use Internet VOIP telephony with the normally familiar phone numbers without using the phone company's normal telephony infrastructure, comprising at least one of the following steps:
a. A single phone is used which can be used both for normal phone line and for IP telephony directly through the Internet;
b. A single phone is used which can automatically switch between normal phone line to IP telephony directly through the Internet;
c. In order to solve the problem of compatibility of numbers, one or more phone-table server databases are available over the Internet, so that the Internet identity of users can be linked to their phone numbers, so that when dialing a “normal” number through the Internet, the system automatically first goes to one of these phone-number-servers to check if such a phone number already has an Internet identity linked to it;
d. In order to prevent people from illegally “hijacking” a phone number of a person or a company and linking it to the wrong Internet identity, users can get an entry that links a phone number with a given Internet identity only upon submitting sufficient evidence that they are indeed who the claim to be and indeed own the phone number in question or have the right to assign it;
e. If the user is connected through ADSL or VDSL, since at least the phone company's switchboard and/or the ISP can know both real the phone number though which the user is connected and his/her IP address, this address can be automatically updated in the special phone-server Databases.

31. The method of claim 30 wherein at least one of the following features exists:
a. A special phone is used with has this switching ability;
b. A switchbox with this switching ability is used, and the user plugs into said switchbox a normal phone, and the switchbox itself is connected both to the normal phone line and to the Internet;
c. If the ADSL/VDSL modem is also a router or is coupled to a router, both the computer and the special switchbox or special phone can be connected directly to the router;
d. If a normal ADSL or VDSL modem without a router is used, the switchbox (or special phone) is connected to the modem only through the computer, or the computer is connected to the modem only through the special switchbox (or special phone);
e. When an incoming call arrives, the switch-box or special phone automatically routes the appropriate channel to the phone and converts it from digital to analogue data if needed;
f. When the user initiates a call, he/she can indicate by an appropriate switch or an appropriate prefix which type of phone call he/she prefers it to be;
g. When the user initiates a call, the system by default first tries to make it an Internet-phone call and only if that is not possible then the system automatically reverts to normal phone call;
h. The system indicates to the user which type of phone call has been established.

32. The method of claim 30 wherein the ISP and/or the Phone company and/or another special authority can issue the user at least one of:
a. A special phone that contains the switchbox in it;
b. A special switchbox which contains within its hardware a unique code that identifies the user and links him/her to one or more authorized phone numbers;
c. A special smart card or other hardware or physical key which can be inserted in these special telephones or switchboxes or coupled to it by RFID or other short range wireless technology and identifies the user and links him/her to one or more authorized phone numbers.

33. The method of claim 32 wherein wherever the user connects said special phone and/or switchbox and/or smart card and/or other hardware, at least one of the following features exists:
a. This automatically become his/her authorized link as long as it is connected;
b. The ISP is automatically instructed to automatically update the special Internet Phone-table servers with the current IP to which the user is connected, thus automatically routing all the calls to and/or from his phone number to that IP address.

34. The method of claim 30 wherein at least one of the following features exists:
a. The ISP automatically invalidates the entry in the Phone table servers that links to that IP address as soon as the user disconnects from that Internet link and/or removes the special hardware ID that identifies him/her, so that any subsequent attempts by someone else to phone that user through the Internet will not be directed to that IP address;
b. If someone tries to phone a user through the Internet and the relevant link in the Internet Phone-tables servers is no longer valid and/or the user is not currently Online, then the appropriate switchbox of the phoning user automatically switches to phoning through the normal phone company infrastructure;
c. If someone tries to phone a user through the Internet and the relevant link in the Internet Phone-tables servers is no longer valid, then the appropriate switchbox of the phoning user automatically switches to phoning through the normal phone ompany infrastructure and indicates to the phoning user that the link cannot currently be made directly through the Internet and asks the user's authorization if to continue with the call or not or try again later through the Internet;
d. The phoning user has an option of automatic “Internet Phone redialing” attempts so that the system automatically checks again intermittently if the Phone-tables servers entry for the desired called user have been updated with a new currently valid IP address and/or if the desired user has become Online again.

35. The method of claim 34 wherein when the desired user becomes available through automatic “Internet Phone redialing” at least one of the following features exists:
a. The system informs the calling user by a special ring that direct Internet connection to the desired user is now available and then if the phoning users picks up the phone, connects to the desired user directly through the Internet;
b. The system first tries to establish the actual connection through the internet and then uses a special ring to alert the phoning user, but in that case the corresponding Internet phone at the called user only gets a notice that a phone call is pending but is not instructed to actually ring as long as the phoning user has not picked up the phone.

36. The method of claim 30 wherein the IP phone or the switchbox has the ability to indicate if the user is busy with another phone call and at least one of the following features exists:
a. If a normal phone-call comes in and the user is currently talking on the phone (either normally or through the Internet) then the switchbox or the special phone or the system can indicate to the phone company that the line is busy and/or indicate to the user that there is an incoming call;
b. If the incoming call is through the Internet telephony, and the user is currently speaking with someone else through the normal telephony infrastructure or through the direct Internet telephony, the Internet phone protocol indicates a busy signal to the calling user and/or indicate to the user that there is an incoming call.

37. (canceled)

38. The method of claim 30 wherein the phoning user can ring the desired user through normal telephony and if both users are near their computer or near some other Internet link that they can use, then at least one of the following features exists:
a. They can both for press some button on the phone or on the switchbox or for activate some option in the computer, and then the phone-call can immediately be switched to direct IP telephony through the internet without them having to hang-up and reconnect;
b. As soon as one of them requests the switch to IP telephony, his system automatically informs the other user's system, and then the other user's system automatically checks if the other user can also revert to IP telephony and in that case switches over automatically even if the other user has not pressed the convert switch;
c. The two phones automatically check if they can make the switch into direct IP telephony and if it is possible then they automatically make this switch even without any request on part of either of the users;
d. If the calling user does not know the Internet phone number of the called user and/or his/her current IP address and/or other data needed for direct VOIP contact, the calling user's phone can first call the other user through normal telephony and then automatically exchange internet phone numbers with the called user's phone and/or exchange other internet information, and then the two phones can immediately automatically switch to IP telephony;
e. This can work automatically with cellular phones, so that the cellular phone automatically includes also the special ID that uniquely identifies the user, and if the user is near enough to some Internet link, the phone can automatically revert to IP telephony;
f. If only one of the users is near an Internet link the phone call can automatically revert to IP telephony on this side and normal Cellular or non-cellular telephony on the other user's side.
